(19) United States
(12) Patent Application Publication
(10) Pub. No.: US 2017/0124946 A1
(43) Pub. Date: May 4, 2017

(54) DISPLAY DEVICE

(71) Applicant: Japan Display Inc., Tokyo (JP)

(72) Inventors: Ilin WU, Tokyo (JP); Duzen Peng, Tokyo (JP)

(21) Appl. No.: 15/286,882

(22) Filed: Oct. 6, 2016

(30) Foreign Application Priority Data
Nov. 2, 2015 (JP) 2015-215538

(51) Int. Cl. G09G 3/3233

(52) U.S. Cl. CPC G09G 3/3233; G09G 2310/061; G09G 2320/045; G09G 2300/0819

(57) ABSTRACT

A display device is provided including a light emitting element, a first transistor formed by a P-MOS arranged between a first power source and the light emitting element, a first switching element connected between a gate electrode of the first transistor and a data line of the first transistor, a second switching element connected between a source electrode of the first transistor and the first power source, a third switching element connected between a drain electrode of the first transistor and an anode of the light emitting element, a first capacitor connected between the gate electrode of the first transistor and the source electrode, and a second capacitor connected between the source electrode of the first transistor and the first power source, wherein in a reset time period the first switching element is turned ON, the second switching element is turned ON, and the third switching element is turned OFF.

### CROSS-REFERENCE TO RELATED APPLICATIONS

This application is based upon and claims the benefit of priority from the prior Japanese Patent Application No. 2015-215538, filed on Nov. 2, 2015, the entire contents of which are incorporated herein by reference.

### FIELD

The present invention is related to a display device. Specifically, the present invention is related to a pixel and an organic electric field light emitting display device using the pixel, in particular, a pixel and display device using the pixel having a high level of uniformity, and a reduced kink phenomenon of a drive transistor and low light leakage.

### BACKGROUND

In recent years, various types of flat display device have been disclosed which can reduce weight and volume which are disadvantages of a cathode ray tube. A liquid crystal display device, field emission display device, plasma panel, organic light emitting display device are examples of a flat display device.

Among such flat display devices, an organic light emitting display device displays an image using an organic light emitting diode which emits generates light by the recombination of electrons and holes. This type of organic light emitting display device has the advantages of fast response speeds and can be driven with relatively low consumption power.

An organic electroluminescence (referred to herein as organic EL) display device is arranged with a light-emitting element in each pixel and displays an image by individually controlling the emitted light. A light-emitting element includes a structure in which a layer (referred to herein as “light emitting layer”) including an organic EL material is sandwiched between a pair of electrodes distinguished as an anode electrode and a cathode electrode. In an organic EL, electrons and holes are injected by applying voltage to the cathode and anode. The electrons and holes combine in the light emitting layer and surrounding molecules are excited by the energy produced by the combination. Light is emitted by the discharged energy when the molecules again return to a ground state from an excited state.

In an organic EL display device, one electrode is arranged in each pixel as an individual pixel electrode and the other electrode is arranged as a common electrode which bridges a plurality of pixels and is applied with a common voltage. The organic EL display device controls the emitted light by a pixel by applying the voltage of the pixel electrode to each pixel with respect to the voltage of the common electrode.

An organic EL display device which realizes full color by combining a white light emitting element and a color filter is generally formed by bonding a color filter substrate with an array substrate.

An array substrate includes a plurality of light emitting elements arranged in a matrix shape. A color filter substrate is arranged with color filters of each color R (red), G (G) and B (blue) and a light shielding layer (also called a black matrix) which partitions color filters of each color.

A transistor which controls a voltage applied to an organic EL suffer from what is called a kink phenomenon. Specifically, since an outflow destination of holes generated by impact ionization does not exist in a field effect transistor (as one of a thin film transistor), not only is a simple current amplified, but an unstable phenomenon (kink phenomenon) is produced due to a variation in potential of the accumulated holes.

This occurs when impact ionization occurs (In the case where a high electric field is applied to a semiconductor or insulator, electron or hole carriers impact atoms or molecules which form a material, and a plurality of carriers are produced at the same time as ionization).

A kink phenomenon is generally known as a phenomenon in which a drain current changes from a certain voltage value to an irregular bump shape when the drain voltage dependency of a drain current is measured and a step shaped waveform is formed.

So far, various methods such as changing an array process or design changes have been attempted as a method for reducing a kink phenomenon.

An existing 2.3 transistor pixel circuit uses a N type DRT in a main EL drive circuit. However, a problem of low brightness uniformity exists due to a large kink phenomenon of a saturation current produced by a N type DRT. In addition, there is also a problem of worsening BS loss due to a kink phenomenon. Thus, it is necessary to improve the problems of low brightness uniformity and BS loss.

In order to improve these problems, a technology has been disclosed which uses a P type DRT for reducing a kink phenomenon (Japanese Laid Open Patent Publication No. 2009-301005). More specifically, in the document, a pixel is arranged with an organic light emitting diode, a second transistor connected between a first power source and the organic light emitting diode for controlling the amount of current supplied from the first power source to the organic light emitting diode, a third transistor connected between a first electrode of the second transistor and the first power source and which is turned OFF when a light emitting control signal is supplied to a light emitting control line, a first transistor connected between a gate electrode of the second transistor and a data line and which is turned ON when a scanning signal is supplied to a scanning line, a first capacitor connected between a gate electrode of the second transistor and a first electrode, and a second capacitor connected between a first electrode of the second transistor and the first power source. This uses a short channel effect, and it stops at being able to reduce a kink phenomenon to a certain extent.

FIG. 1A is a circuit diagram showing a pixel of an organic light emitting display device and FIG. 1B is a timing chart of the same circuit diagram. The time period T1 in FIG. 1B corresponds to a reset in the present application and the time period T2 corresponds to an offset cancel in the present application.

In an offset cancel operation which compensates a threshold voltage of a drive transistor, in the case of a n channel type drive transistor a source potential is changed by setting the source potential to a floating state and a voltage between the gate and source of the drive transistor is set to a threshold voltage Vth. In this state, by writing a data voltage of a signal desired to be displayed in the pixel, a voltage of a data signal compensated with a threshold voltage is stored in a storage capacitor connected to a gate.

### SUMMARY

According to one embodiment of the present invention, a display device is provided including a light emitting element, a first transistor formed by a P channel MOS arranged between a first power source and the light emitting element, a first switching element connected between a gate electrode of the first transistor and a data line of the first transistor, a second switching element connected between a source electrode of the first transistor and the first power source, a third switching element connected between a drain electrode of the first transistor and an anode of the light emitting element, a first capacitor connected between the gate electrode of the first transistor and the source electrode, and a second capacitor connected between the source electrode of the first transistor and the first power source, wherein in a reset time period the first switching element is turned ON, the second switching element is turned ON, and the third switching element is turned OFF.

### BRIEF DESCRIPTION OF DRAWINGS

FIG. 1A is a circuit diagram showing a pixel;

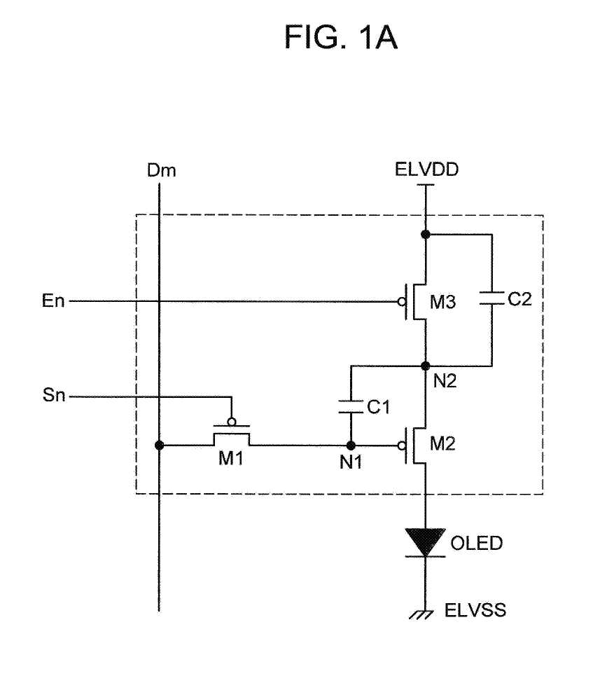

FIG. 1B is a timing chart of the pixel diagram shown in FIG. 1A;

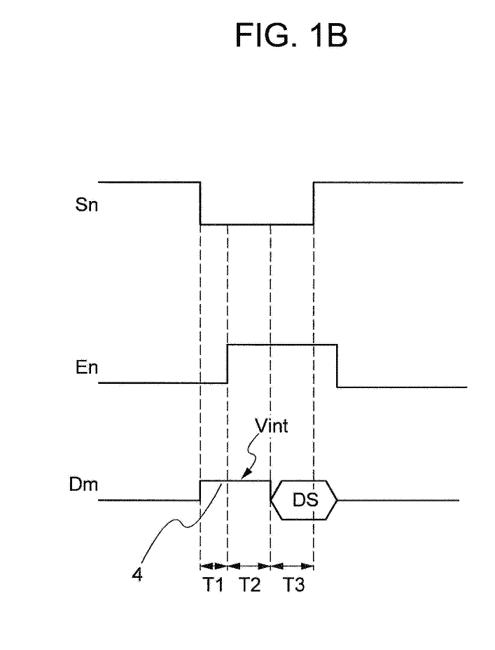

FIG. 2 is a diagram showing a display device related to one embodiment of the present invention;

FIG. 3 is a wave form diagram showing a drive wave form from the scanning drive part and data drive part shown in FIG. 2;

FIG. 4 is a circuit diagram showing an embodiment of the pixel shown in FIG. 2; and

FIG. 5 is a wave form diagram showing a drive wave form of the pixel shown in FIG. 4.

### DESCRIPTION OF EMBODIMENTS

The embodiments of the present invention are explained below while referring to the diagrams. However, it is possible to perform the present invention using various different forms, and the present invention should not be limited to the content described in the embodiments exemplified herein. Although the width, thickness and shape of each component are shown schematically compared to their actual form in order to better clarify explanation, the drawings are merely an example and should not limit an interpretation of the present invention. In addition, in the specification and each drawing, the same reference symbols are attached to similar elements and elements that have been mentioned in previous drawings, and therefore a detailed explanation may be omitted where appropriate.

When an offset cancel operation is attempted in the circuit described in Japanese Laid Open Patent Publication No. 2009-301005, a voltage is applied from a drive transistor (DRT) to a light emitting element in a time period T1 which is a reset time period and light leakage occurs.

Thus, the present embodiment discloses a display device which does not produce light leakage during a reset time period while continuing to solve problems caused by a kink phenomenon.

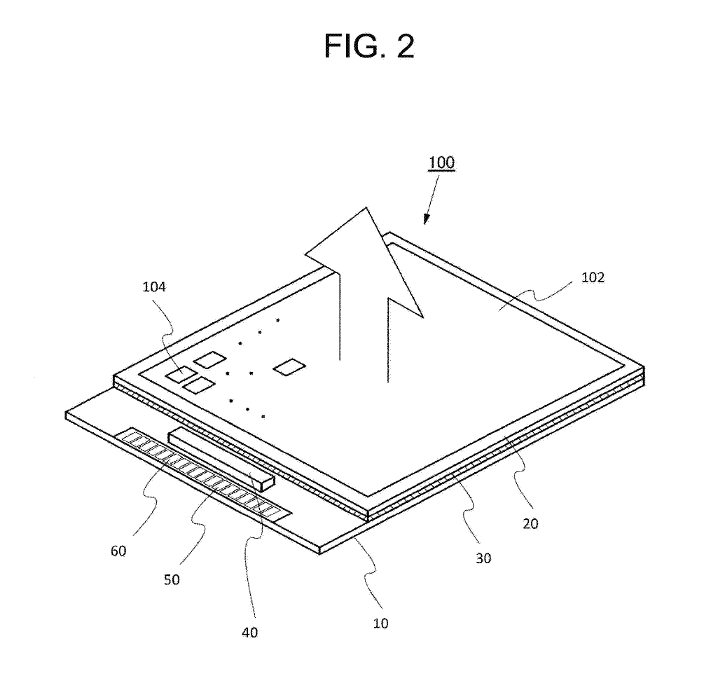

The embodiments related to the present invention are explained below while referring to the attached diagrams FIG. 2 to FIG. 5. A structure of a display device 100 related to the present embodiment is explained while referring to FIG. 2. FIG. 2 is a perspective diagrams showing a structure of a display device 100 related to the present embodiment. The display device 100 related to the present embodiment includes a first substrate 10, a second substrate 20, a plurality of pixels 104, a sealing member 30, a terminal region 50 and a connection terminal 60.

A display region 102 is arranged in the first substrate 10. The display region 102 is formed by arranging the plurality of pixels 104. The second substrate 20 is arranged as a sealing member on the upper surface of the display region 102. The second substrate 20 is fixed to the first substrate 10 by the sealing member 30 which encloses the display region 102. The display region 102 formed in the first substrate 10 is sealed by second substrate 20 which is a sealing member and the sealing member 30 so as not be exposed to the air. Light emitting element arranged in a pixel 104 is controlled by adopting such a sealing structure not to be degradation.

The terminal region 50 is arranged at one end part of the first substrate 10. The terminal region 50 is arranged on the outer side of the second substrate 20. The terminal region 50 is formed by a plurality of connection terminals 60. A wiring substrate which connects devices which output a display signal or a power supply and a display panel is arranged in the connection terminal 60. The connection point between the wiring substrate and connection terminal 60 is exposed to the exterior.

A driver IC 40 which outputs a display signal input from the terminal region 50 to the display region 102 is arranged in the first substrate 10.

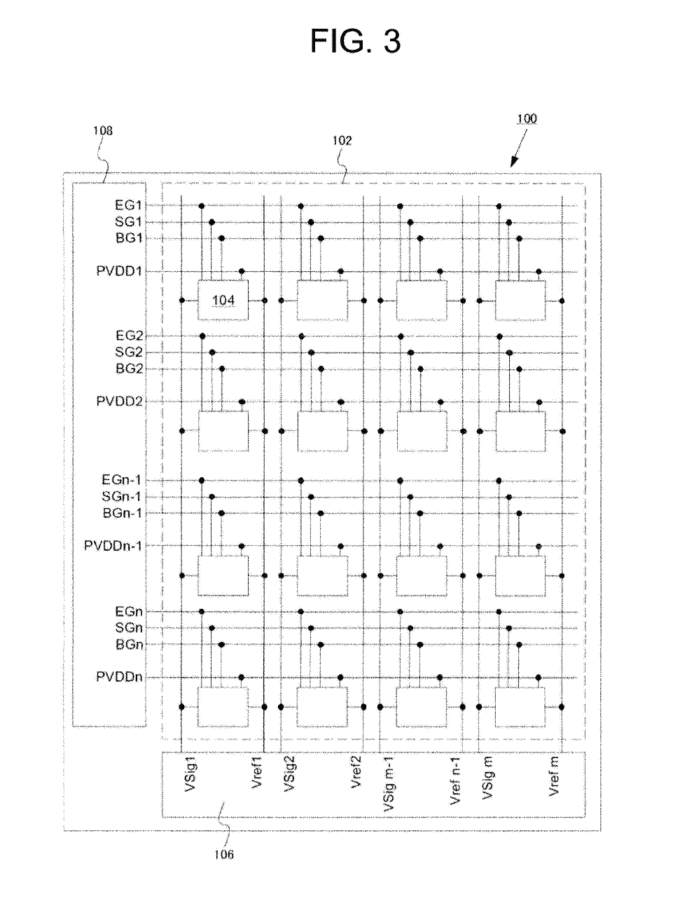

FIG. 3 is a diagram for explaining a circuit structure of the display device 100 related to the present embodiment. The display device 100 related to the present embodiment is arranged with a plurality of pixel circuits 104 arranged in a matrix shape in the display region 102, a signal line drive circuit 106 and a scanning line drive circuit 108.

A signal is output from the scanning line drive circuit 108 to first scanning signal lines EG1˜EGn, second scanning signal lines SG1˜SGn, and third scanning signal lines BG1˜BGn. The first scanning signal lines EG1˜EGn, second scanning signal lines SG1˜SGn, and third scanning signal lines BG1˜BGn are wires arranged in each row in the display region 102. In addition, first power supply lines PVDD1˜PVDDn are arranged corresponding to these signal lines. Here, the symbol [n] is an integer and corresponds to the number of each signal line arranged in the display region 102.

The signal line drive circuit 106 outputs a video signal VsigV to video signal lines Vsig1˜Vsigm, and outputs an initialization signal VrefV to initialization signal lines Vref1˜Vrefm. In the display region 102, the video signal lines Vsig1˜Vsigm and initialization signal lines Vref1˜Vrefm are arranged corresponding to each column. Here, symbol [m] is an integer and corresponds to the number of each signal line arranged in the display region 102.

Although a voltage supplied to the first power supply line PVDD in FIG. 3 is divided for each row, the present invention is not limited to this structure and may be set in common across all rows or a plurality of rows. In addition, although the initialization signal line Vref and the video signal line Vsig are each respectively arranged separated into different signal lines, they may also be set in common to the same signal line and be supplied by switching these signals. In this case, the initialization signal lines Vref, a switch VsigSW and switch VrefSW have a shape so as to be arranged in the signal line drive circuit 106.

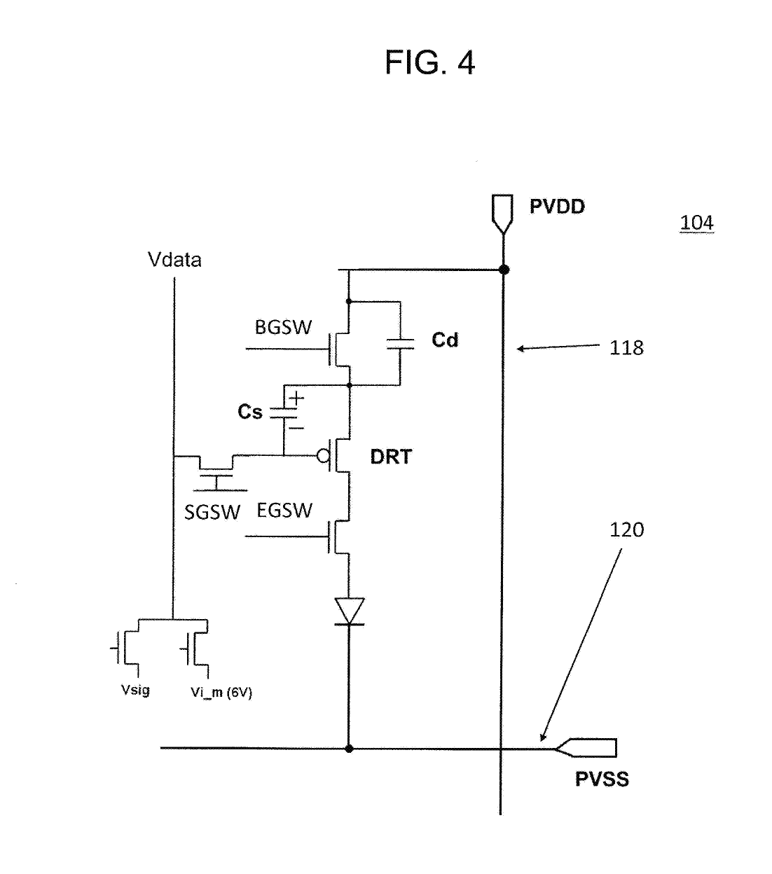

FIG. 4 shows an equivalent circuit of a pixel 104. The pixel 104 is formed including a drive transistor DRT and a light emitting element 112. The light emitting element 112 is arranged between a first power supply 118 and a second power supply 120. A different voltage is supplied to the first power supply 118 and second power supply 120. For example, a first power supply voltage PVDD (for example 12V) is supplied to the first power supply 118, and a second power supply voltage PVSS (for example OV) lower than the first power supply voltage PVDD is supplied to the second power supply 120.

The light emitting element 112 includes a structure in which a layer (light emitting layer) including an organic EL material sandwiched between a pair of electrodes, one of which is distinguished as an anode electrode and the other as a cathode electrode, a voltage is applied to the cathode and the anode, electrons and holes are injected and light is emitted. The light emitting element 112 is a two-terminal element and includes the same rectification properties as a diode. The light emitting element 112 is applied with a voltage equal to or more than a light emitting threshold voltage and light is emitted when a forward current flows. Within the scope of actual operation, the intensity of the light emitted by the light emitting element 112 changes in proportion to an increase or decrease in the amount of current.

A data line “Vdata” is arranged between the switch VsigSW and switch VrefSW, and a switch SGSW. A video signal line Vsig and initialization signal line Vref are connected to the data line “Vdata”, the video signal line Vsig is controlled by the switch VsigSW and the initialization signal line Vref is controlled by the switch VrefSW. In the display region 102, the video signal line Vsig and initialization signal line Vref are arranged corresponding to each column.

The pixel circuit 104 includes at least a drive transistor DRT, light emitting element 112 and a storage capacitor Cs. The drive transistor DRT is, for example, an insulation gate type field effect transistor and includes a gate as a control terminal, and a source and drain as input/output terminals. The drive transistor DRT is arranged between the first power supply 118 and light emitting element 112. The drive transistor DRT and light emitting element 112 are connected in series, the first power supply 118 is connected to the drive transistor DRT side, and the second power supply 120 is connected to the light emitting element 112 side. A switch EGSW, switch SGSW and switch BGSW are each respectively turned ON and OFF by a first signal line EG, second signal line SG, and third signal line BG. In the case where the switch EGSW, switch SGSW and switch BGSW are transistors, the first signal line EG, second signal line SG, and third signal line BG are each connected to the gate of each switch respectively and controlled by applying a voltage via each signal line. One end of the storage capacitor Cs and one end of the switch SGSW are connected to the gate of the drive transistor DRT. One end of the switch SGSW is connected to the gate of the drive transistor DRT and the other end is connected to a data line “Vdata”. The other end of the storage capacitor Cs is connected to the first power supply 118 via the switch BGSW. One end of the switch BGSW is connected to the first power supply 118 and the other end is connected to an end of the drive transistor DRT on the first power supply 118 side. One end of the storage capacitor Cs is connected to the first power supply 118 and the other end is connected to an end of the drive transistor DRT on the first power supply 118 side. The switch EGSW is connected between the drive transistor DRT and the light emitting element 112. A capacity value of a storage capacitor Cd is preferred to be twice or more and ten times or less the capacity value of the storage capacitor Cs. The case where a P type transistor is used as the drive transistor DRT is shown in FIG. 4.

The display device 100 related to the present embodiment is driven including four time periods, a reset time period (Reset), offset cancel time period (OC), writing time period (VsigP), and light emitting time period (Emission).

FIG. 4 is s circuit plan view diagram of a pixel circuit 104. The anode electrode of the light emitting element 112 is connected to the pixel circuit 104 and the cathode electrode is connected to a second power supply PVSS. This type of light emitting element 112 generates light at a certain luminosity corresponding to an amount of current supplied from the pixel circuit 104. Here, the voltage of the second power supply PVSS is set at a voltage lower than a voltage of the first power supply PVDD. Furthermore, the switch elements SG, EG and BG may be an n type or p type. In the present specification, only n types are described for simplicity.

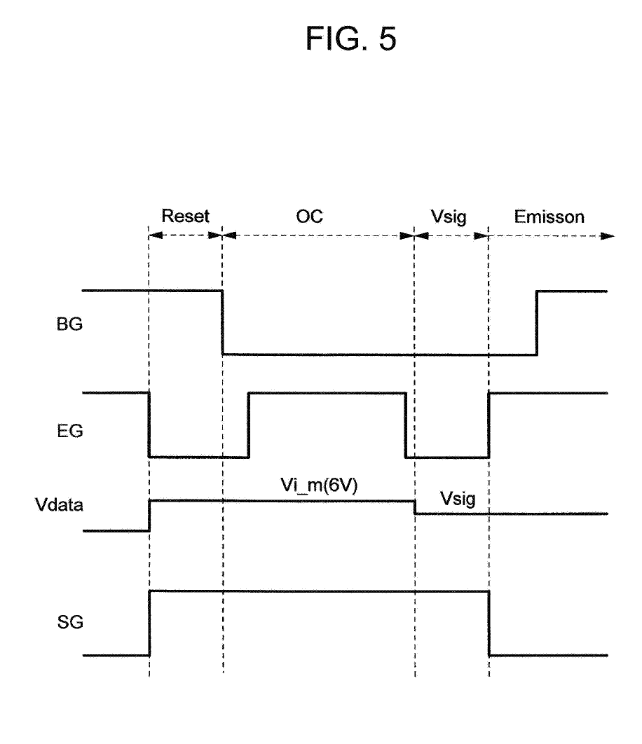

The operation process of a pixel 104 is explained based on the timing chart in FIG. 5. In a reset time period Reset, a scanning signal is supplied to the second scanning signal line SG and the switch SGSW is turned ON. An initialization signal VrefV is supplied to the data line Vdata so that the switch VsigSW is turned OFF and the switch VrefSW is turned ON. A scanning signal is supplied to the third scanning signal line BG, the switch BGSW is turned ON, a scanning signal is supplied to the first scanning signal line EG and the switch EGSW is turned OFF. The charge of the storage capacitor Cd becomes OV and the charge of the storage capacitor Cs is removed. At this time, since the switch EGSW is turned OFF, a current is prevented from flowing to the light emitting element 112. In this way, the light emitting element 112 emits light during the reset time period Reset and it is possible to avoid defects such as the occurrence of light leakage.

During an offset cancel time period OC, other than the switch EGBG being turned OFF, a scanning signal being supplied to the first scanning signal line EG and the switch EGSW being turned ON, the state remains the same as during a reset time period Reset. Since the voltage of an initialization signal is set to about 6V for example, and a higher voltage than a threshold voltage Vth of the drive transistor DRT is applied to the gate source of the drive transistor DRT, a current flow to the light emitting element 112 via the drive transistor DRT. As a result, a threshold voltage Vth is stored in the storage capacitor Cs.

During a writing time period VsigP, a video signal VsigV is supplied to a data line “Vdata” so that the switch VsigSW is turned ON and the switch VrefSW is turned OFF. A scanning signal is supplied to the first scanning signal line EG and the switch EGSW is turned OFF. Other operations are the same as during the offset cancel time period OC. As a result, a voltage shown in the formula 1 below is stored in the storage capacitor Cs so that a video signal VsigV is supplied.

Vth+(VrefV−VsigV)×Cd/(Cs+Cd)

(Here, Vth is a voltage value of a threshold voltage Vth, VrefV is a voltage value of an initialization signal VrefV, VsigV is a voltage value of a video signal VsigV, Cd is a capacity value of a capacitor Cd, and Cs is a capacity value of a capacitor Cs)

During the light emitting time period Emission, a scanning signal is supplied to the second scanning signal line SG and the switch SGSW is turned OFF. No particular care is required for the data line “Vdata” since there is no problem whatever signal is applied due to the switch SGSW being turned OFF. A scanning signal is supplied to the third scanning signal line BG, the switch BGSW is turned ON, a scanning signal is supplied to the first scanning signal line EG and the switch EGSW is turned ON. A voltage having a value such as that shown in formula 1 in the storage capacitor Cs is applied between the gate and source of the drive transistor DRT. A current flow from the first power supply PVDD, through the drive transistor DRT and through the light emitting element 112 towards the second power supply PVSS so that the switch BGSW and switch EGSW are turned ON and the light emitting element 112 emits light. Since a voltage value shown by the term including a voltage value of the video signal VsigV is stored in the storage capacitor Cs in addition to the threshold voltage Vth term as in formula 1, there is no dependence on a threshold voltage Vth of a drive transistor DRT, and a value of a current which flows to the drive transistor DRT which is dependent on a voltage value of the video signal VsigV is determined. In this way, it is possible to reduce light emitting variance which is dependent on a threshold voltage Vth of a drive transistor DRT. Furthermore, it is possible to reduce light emitting variance caused by a kink phenomenon by using a p channel MOS transistor in a drive transistor DRT.

What is claimed is:

1. A display device comprising:
a light emitting element;
a first transistor formed by a P channel MOS arranged between a first power source and the light emitting element;
a first switching element connected between a gate electrode of the first transistor and a data line of the first transistor;
a second switching element connected between a source electrode of the first transistor and the first power source;
a third switching element connected between a drain electrode of the first transistor and an anode of the light emitting element;
a first capacitor connected between the gate electrode of the first transistor and the source electrode; and
a second capacitor connected between the source electrode of the first transistor and the first power source;
wherein
in a reset time period
the first switching element is turned ON
the second switching element is turned ON
the third switching element is turned OFF; and
a reset signal is input from the date line.

2. The display device according to claim 1, wherein at least one of the first switching element, the second switching element and the third switching element is a transistor.

3. The display device according to claim 1, wherein at least one of the first switching element, the second switching element and the third switching element is a field effect transistor.

4. The display device according to claim 1, wherein at least one of the first switching element, the second switching element and the third switching element is a thin film field effect transistor.

5. The display device according to claim 1, wherein at least one of the first switching element, the second switching element and the third switching element is a thin film transistor.

6. The display device according to claim 1, wherein at least one of the first switching element, the second switching element and the third switching element is a P type field effect transistor.

7. The display device according to claim 1, wherein at least one of the first switching element, the second switching element and the third switching element is an N type field effect transistor.

8. The display device according to claim 1, wherein in an offset period after the reset period;
the first switching element is turned ON
the second switching element is turned OFF
the third switching element is turned ON; and
a reset signal is input from the date line.

9. The display device according to claim 8, wherein in a data writing period after the off reset period;
the first switching element is turned ON
the second switching element is turned OFF
the third switching element is turned OFF; and
a data signal is input from the date line.

10. The display device according to claim 9, wherein in a light emitting period after the data writing period;
the first switching element is turned OFF
the second switching element is turned ON, and
the third switching element is turned ON.
